(19) United States
(12) Patent Application Publication
(10) Pub. No.: US 2003/0011735 A1
(43) Pub. Date: Jan. 16, 2003

(54) Display device and display device assembling method

(76) Inventor: Takahira Kato, Kariya-city (JP)

Correspondence Address: LAW OFFICES OF DAVID G. POSZ, 2000 L STREET, N.W., SUITE 200, WASHINGTON, DC, 20036, US

(21) Appl. No.: 10/158,930

(22) Filed: Jun. 3, 2002

(30) Foreign Application Priority Data
Jul. 12, 2001 (JP) 2001-212556

(51) Int. Cl. G02F 1/1333

(52) U.S. Cl. 349/149

(57) ABSTRACT

A display device has the first and second flexible printed circuits (FPCs). An end of the first FPC is connected to a terminal on the second FPC. The first and second FPCs transmit electrical signals to a heater and an LCD panel, respectively. Only the first FPC is connected to an external part. With above configuration, electrical signals are inputted to both LCD and heater. A process of electrically connecting the display device to the external part is simplified, because only the first FPC is connected to the external part which controls both LCD and heater.

### CROSS REFERENCE TO RELATED APPLICATION

This application is based on and incorporates herein by reference Japanese Patent Application No. 2001-212556 filed on Jul. 12, 2001.

### FIELD OF THE INVENTION

The present invention relates to a display device utilizing an LCD panel and an assembling method for the device.

### BACKGROUND OF THE INVENTION

A display device utilizing an LCD panel is generally mounted in a meter panel to display information that a driver needs. The response characteristic of the LCD is exacerbated under low temperature. To maintain the LCD at a proper temperature, a transparent plane heater is mounted on the LCD surface.

The LCD and heater generally have conductive members, such as flexible printed circuit (FPC) boards. Those conductive members are used for transmitting electrical signals to the LCD and heater from other parts. The LCD and heater are separately assembled and glued together. However, the LCD and heater are not electrically connected. Therefore, when mounting the display device in the meter panel, each conductive member of the LCD or the heater is electrically connected to external parts. This requires a large amount of man-hours.

### SUMMARY OF THE INVENTION

The present invention therefore has an objective to provide a display device and its assembly method that reduces man-hours required for making electrical connections of the device.

According to the present invention, a conductive member for an LCD and a conductive member for a heater are electrically connected. With this configuration, electrical signals from external parts are transmitted to the LCD and heater via either of the conductive members that is electrically connected to the external parts. Since connecting points with the external parts are reduced, the amount of man-hours required for making electrical connections can be reduced.

### BRIEF DESCRIPTION OF THE DRAWINGS

The above and other objectives, features and advantages of the present invention will become more apparent from the following detailed description made with reference to the accompanying drawings. In the drawings:

FIG. 1A is a front view of a display device according to the first embodiment of the present invention;

FIG. 1B is a side view of the display device shown in FIG. 1A;

FIG. 2A is a front view of a heater included in the device shown in FIG. 1A;

FIG. 2B is a side view of the heater shown in FIG. 2A;

FIG. 3 is a block diagram showing an electrical circuit of the display device according to the first and second embodiments of the present invention;

FIG. 4 is a front view of a display device according to the second embodiment of the present invention;

FIG. 5 is a side view of the display device shown in FIG. 5;

FIG. 6 is a front view of a modified display device shown in FIG. 1A;

FIG. 7A is a front view of another modified display device shown in FIG. 1A; and

FIG. 7B is a side view of the modified display device shown in FIG. 1B.

### DETAILED DESCRIPTION OF THE PREFERRED EMBODIMENT

Preferred embodiments of the present invention will be explained with reference to the accompanying drawings. In the drawings, the same numerals are used for the same components and devices.

[First Embodiment]

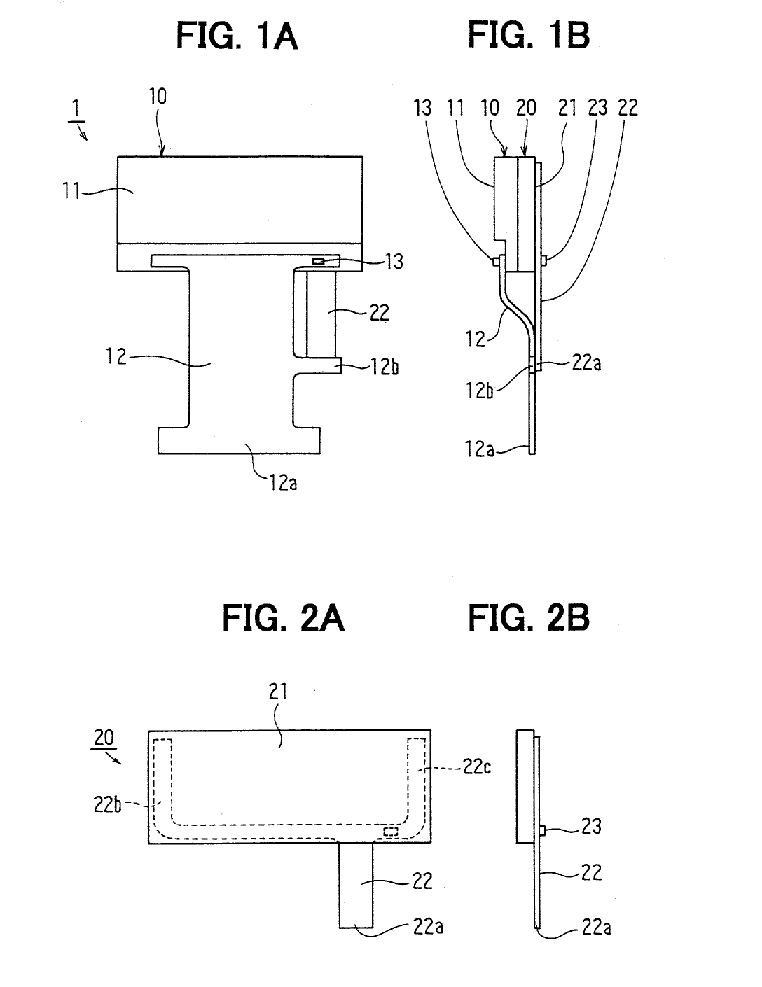

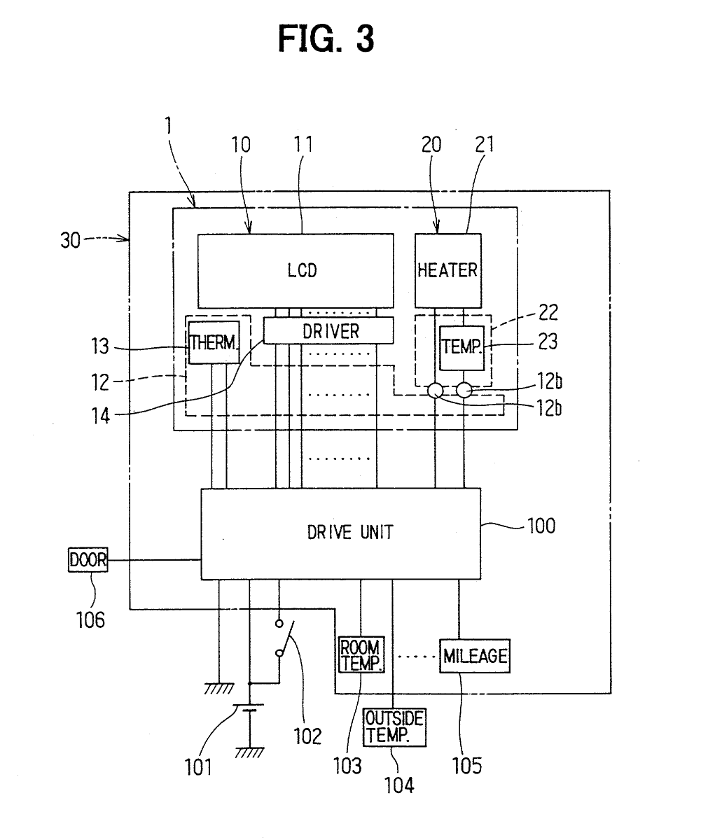

Referring to FIGS. 1A and 1B, a display device 1 has an LCD panel 10 and a heater 20. The device 1 is connected to an external drive unit 100 that controls displaying operation of the device 1 as shown in FIG. 3. The device 1 performs the displaying operation based on drive signals from the drive unit 100. The drive unit 100 also controls a power supply to the heater 20 to maintain the LCD 10 at a proper temperature.

Referring to FIG. 3, the LCD 10 has a display 11, a driver 14, a flexible printed circuit (FPC) board 12. The display 11 has a pair of glass substrates (not shown). On the inner surface of the glass substrates, transparent electrodes are provided. A liquid crystal material is sealed between the glass substrates.

The driver 14 is an integrated circuit (IC). It controls a voltage application to the transparent electrodes so that the displaying operations are properly performed based on the electrical signals from the unit 100. When the device 1 is installed in an instrument panel, an end 12a of the FPC 12 is connected to a printed circuit board (PCB) on which the unit 100 is mounted. When an electrical signal is supplied to the driver 14 via the FPC 12, the displaying operation starts.

A terminal 12b is extended from the FPC 12 and located between the end 12a and display 11. The terminal 12b is provided to electrically connect the LCD 10 with the heater 20. A thermistor 13 is a temperature sensor mounted on the FPC 12 at an appropriate position for a display temperature measurement. Power is supplied to the heater 20 based on the measured temperature so that the display is maintained at the predetermined temperature.

Referring to FIGS. 2A and 2B, the heater 20 has a heating element 21 and an FPC 22. The heating element 21 has a transparent heating material affixed to the surface of a transparent glass plate. The plate is approximately in the same size and shape as the display 11. An example of the heating material is an indium tin oxide (ITO).

The FPC 22 has two arms 22b and 22c fixed to the heating element 21 along its vertical edges. The FPC 22 refers to as the second conductive member and transmits electrical signals. The end 22a of the FPC 22 is soldered to the terminal 12a. Therefore, power is supplied to the heater 20 via the FPCs 12 and 22. This requires only one connecting point to make an electrical connection between the device 1 and external parts. Therefore, man-hours required for soldering can be reduced.

Moreover, a temperature switch is mounted on the FPC 22 to halt a power supply to the heating element 21 when a temperature of the element 21 exceeds a predetermined value. An example of the temperature switch is a positive temperature coefficient (PTC) switch. When the temperature of the PTC switch exceeds the predetermined value, a resistance of the PTC switch is increased. This automatically reduces a current supply to the element 21 to prevent an excessive temperature increase of the heating element 21.

The method for producing the display device 1 includes the following steps.

(1) Mounting the driver 14 on the glass plate of the LCD 10.

(2) Affixing one end of the FPC 12 to the transparent plate that is extended to the glass plate with solder or adhesive.

(3) Mounting the thermistor 13 on the FPC 12.

(4) Fusion bonding or soldering arms 22b and 22c of the FPC 22 onto the heating element 21 along its vertical edges.

(5) Mounting the temperature switch 23 on the FPC 22.

(6) Affixing the heating element 21 to the back of the LCD 10 with a double-faced tape or an adhesive.

(7) Soldering the end 22a of the FPC 22 to the terminal 12b that is located at the middle point of the FPC 12 so that they are electrically connected.

[Second Embodiment]

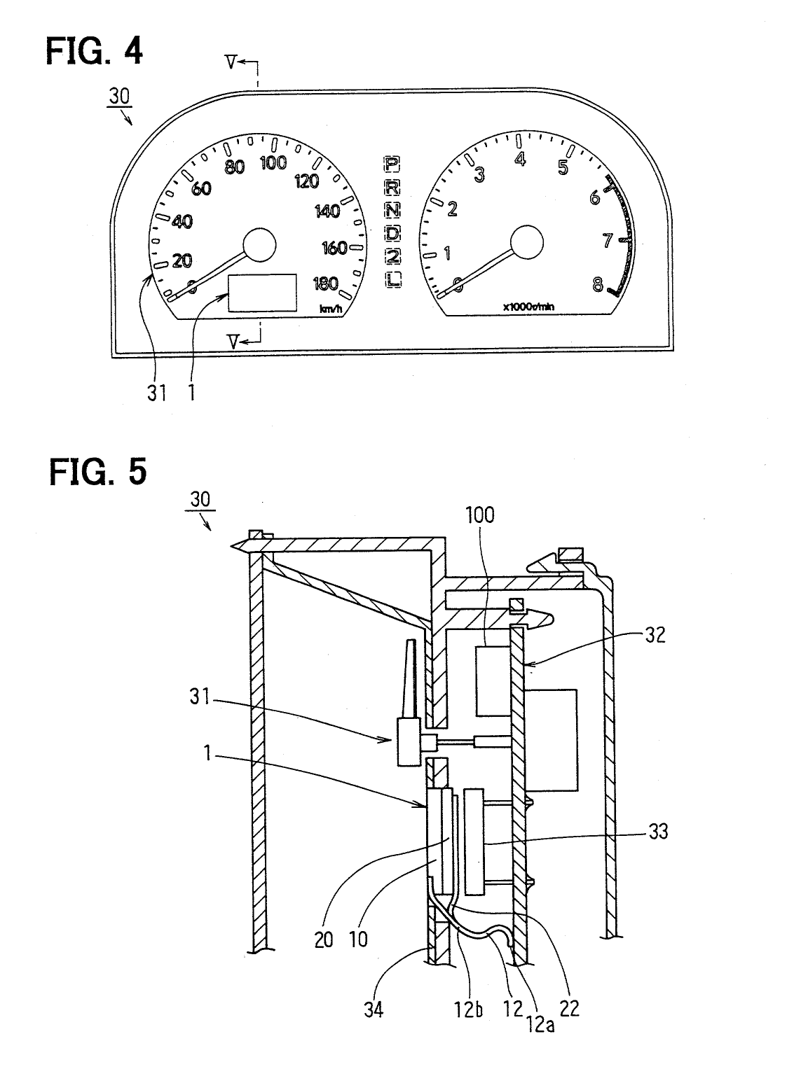

Referring to FIGS. 4 and 5, a display device 30 includes the display device 1 shown in FIGS. 1A and 1B, a speedometer 31, a printed circuit board (PCB) 32, a backlight 33, the drive unit 100 shown in FIG. 3 and a meter case. The display device 1 is installed in a lower part of a display board 34 so that it faces toward a driver. The display board 34 is a part of a speedometer. The end 12a of the FPC 12 is soldered to the printed circuit board (PCB) 32. The FPC 12 transmits electrical signals to the device 1. The PCB 32 has the drive unit 100 that controls display operation of the device 1. The device 1 is connected to the drive unit 100 via the PCB 32.

Referring to FIG. 3, when an ignition (IG) switch 102 is closed, power is supplied to the drive unit 100. Then, the drive unit 100 starts display operation control to the device 1 and power supply control to the heater 20. Various sensors are connected to the drive unit 100. Those sensors include room temperature sensor 103, outside air temperature 104, mileage sensor 105 and door switch sensor 106. The drive unit 100 processes output signals from those sensors and the processed signals are inputted to the device 1 via the FPC 12. Then, the device 1 starts predetermined display operations.

Even when the IG switch 102 is open, power can be supplied to the drive unit 100 by a battery 101. The drive unit 100 starts power supply control to the heater 20 when open and close of a door is detected by the door switch sensor 106. As a result, the LCD 10 is warmed up to the appropriate temperature so that the device 1 can provide stable display operation from the point that the IG switch is closed.

The backlight 33 is mounted on the PCB 32. The device 1 performs display operations in the condition that the display 11 is irradiated with a light from the backlight 33 via the heater 20. This provides good visibility to a driver. Moreover, heat produced by the backlight 33 also warms up the display 11. Since a transparent heating material (e.g., ITO) is used for the heater 20, light from the backlight 33 hardly fades. Therefore, sufficient brightness can be provided. The temperature sensor 13 detects a condition in which sufficient temperature is not provided by the backlight 33 for maintaining the display operation. When that condition is detected, heat is produced until the temperature reaches a predetermined value.

In the device 1, the end 22a of the FPC 22 is soldered to the terminal 12b and the end 12a is electrically connected to the external parts. The other end of FPC 12 is soldered to the transparent electrode on the LCD 10. The terminal 12b is located at the vertical edge of the FPC 12. The arms 22b and 22c of the FPC 22 are soldered to the heater 20.

In the assembly process for the display device 30, the display device 1 and PCB 32 are electrically connected in one step. This reduces man-hours for electrical connecting process of the device 30 in comparison with methods used previously.

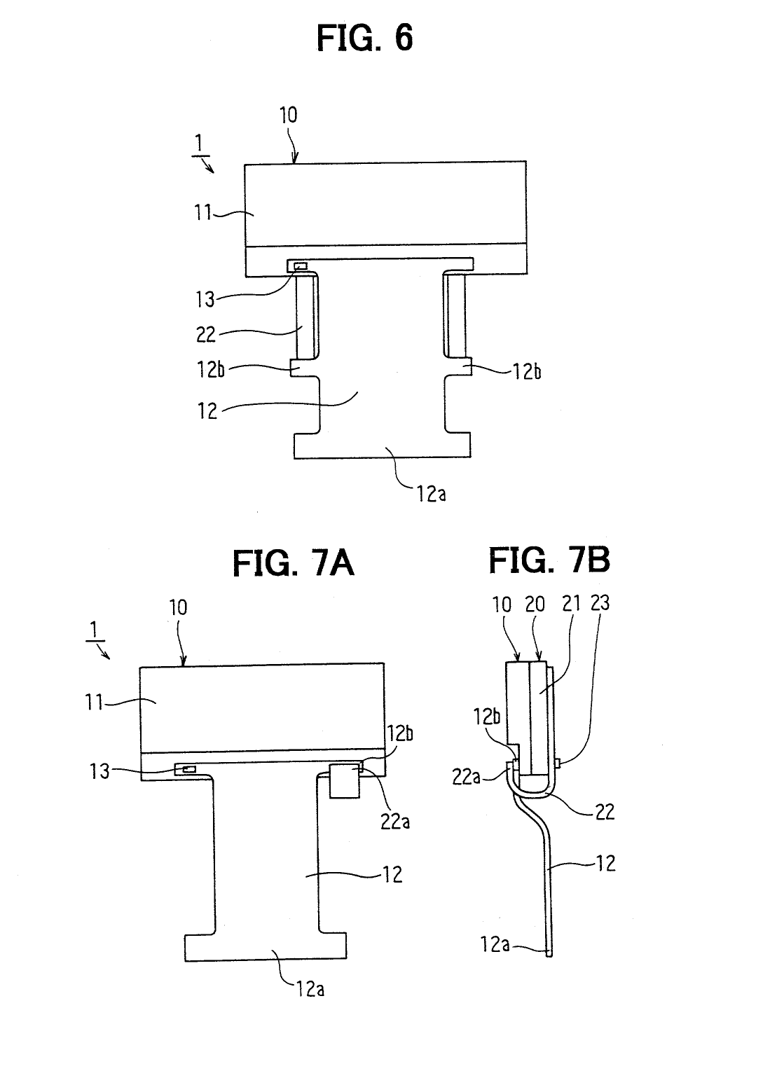

The above embodiments can be modified as shown in FIG. 6. One more terminal 12b is added to the FPC 12. Even with this configuration, only one point of the FPC 12 is soldered for electrically connecting the device 1 with the PCB 32. Therefore, man-hours for electrical connecting process can be reduced.

The above embodiments can be modified as shown in FIGS. 7A and 7B. In this configuration, the terminal 12b is located at the extended part of the FPC 12 on the LCD 10. The end 22a of the FPC 22 is bent so that it wraps under the heater 20 and LCD 10 to be soldered to the terminal 12b. This eliminates unwanted extended part provided at the edge of the FPC 12.

In the above embodiments, the heating element 21 may be mounted on the front of the LCD 10.

What is claimed is:

1. A display device comprising:
an LCD panel;
a heater affixed to the LCD panel for warming up the LCD panel;
a first conductive member that is affixed to the LCD panel and transmits electrical signals to the LCD panel; and
a second conductive member that is affixed to the heater and transmits electrical signals to the heater,
wherein the first and second conductive members are electrically connected and only one of the first and second conductive members is electrically connected to external parts.

2. A display device as in claim 1, wherein the first and second conductive members are flexible printed circuit boards.

3. A display device as in claim 1, wherein the first conductive member has an extended part with which the second conductive member is connected and the second conductive member is mounted on the heater aligning with the extended part.

4. A display device as in claim 1, wherein the first conductive member has only one extended part.

5. A display device as in claim 1, further comprising a temperature sensor, mounted on the first conductive member within the LCD panel, for detecting a temperature on the LCD panel.

6. A display device as in claim 1, further comprising a temperature sensor, mounted on the second conductive member within the heater, for detecting a temperature on the LCD panel.

7. A display device as in claim 1, further comprising:
a drive unit for driving the LCD panel;
a printed circuit board on which the drive unit is mounted; and
a meter case for housing the LCD panel, heater, drive unit and printed circuit board,
wherein the first conductive member is electrically connected to the printed circuit board.

8. A display system as in claim 1, further comprising a backlight that is installed between the heater and printed circuit board.

9. An assembling method for the device that is claimed in claim 1 comprising steps of:
connecting the first conductive member to the LCD panel;
connecting the second conductive member to the heater;
affixing the heater connected to the second conductive member to a surface of the LCD panel;
electrically connecting the first and second conductive members; and
electrically connecting only one of the first and second conductive members to external parts.

10. An assembling method as in claima9, wherein the step of electrically connecting the first and second conductive members further comprising steps of:
providing a terminal extended from an edge of the first conductive member; and
electrically connecting an end of the second conductive member to the terminal.
